(19) United States
(12) Patent Application Publication
(10) Pub. No.: US 2011/0029926 A1
(43) Pub. Date: Feb. 3, 2011

(54) Generating a visualization of reviews according to distance associations between attributes and opinion words in the reviews

(76) Inventors: Ming C. Hao, Palo Alto, CA (US); Umeshwar Dayal, Saratoga, CA (US); Daniel Keim, Sieisslingen (DE); Daniela Oelke, Konstanz (DE)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/462,186

(22) Filed: Jul. 30, 2009

(51) Int. Cl. G06F 3/048

(52) U.S. Cl. 715/835

(57) ABSTRACT

Representations of reviews regarding at least one offering of an enterprise are received, wherein the representations of the reviews contain attributes and opinion words. Distance associations between the attributes and the opinion words in the representations are determined according to a distance mapping strategy that uses distances between the attributes and the opinion words in a section. A visualization of the reviews is generated according to the determined associations.

### BACKGROUND

An enterprise that provides various offerings (goods and/or services), often seeks to collect customer feedback regarding such offerings. The customer feedback can be in the form of reviews that are submitted online (e.g., over the Internet) or received in paper form and subsequently entered into a system. There can be a relatively large number of reviews submitted by customers.

Analyzing reviews can be very helpful to an enterprise, and can aid the enterprise in understanding likes and dislikes of customers with respect to goods and/or services offered by the enterprise. However, having to manually analyze customer reviews can be a time-consuming process, and can involve a large number of personnel hours. In some cases, because of the large volumes of customer reviews, it is impractical to perform a manual analysis. Although some automated techniques exist to provide summaries of opinions expressed in reviews, such mechanisms may not offer the level of flexibility and scalability that may be desired.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are described with respect to the following figures:

FIG. 1 illustrates an example customer review that can be processed by a technique according to some embodiments;

FIG. 2 illustrates an example result produced based on the analysis of the user review of FIG. 1, according to an embodiment;

FIG. 3 illustrates a scatter plot according to an embodiment that depicts a result of analysis of user reviews, according to an embodiment;

FIGS. 4-6 illustrate circular correlation maps produced according to an embodiment;

FIG. 7 is a flow diagram of a process of user review analysis and visualization, according to an embodiment; and

FIG. 8 is a block diagram of an exemplary system incorporating an embodiment.

### DETAILED DESCRIPTION

An enterprise, such as a company, government agency, educational organization, and so forth, may receive feedback in the form of customer reviews regarding one or more offerings of the enterprise. An offering can be a good or service that is provided by the enterprise to customers (also referred to as consumers). The customer reviews can be submitted by customers in electronic form, such as over the web, by electronic mail, and so forth. Alternatively, the reviews can be submitted in paper form, such as on survey cards, with the enterprise subsequently entering the reviews in paper form into electronic form. A “review” refers generally to any feedback (which can be some aggregation of text and other data) submitted by consumers of the enterprise's offering.

For a large enterprise that has a relatively large number of offerings or a relatively large number of customers, the number of reviews can be quite large. With a large number of customer reviews, it may be difficult for the enterprise to efficiently understand opinions expressed by customers in the customer reviews. Manual analysis is typically not practical in view of the relatively large number of customer reviews. Moreover, conventional automated techniques of analyzing reviews may not provide the output in a form that can be easily used by relevant personnel of the enterprise. In addition, conventional techniques of analyzing reviews may not be scalable, and thus may not be able to handle ever-expanding volumes of customer reviews in an efficient and flexible manner.

In accordance with some embodiments, an automated analysis and visualization mechanism is provided to enable automated analysis of customer reviews to extract positive and negative opinions expressed by customers in the reviews, and to provide an interactive visualization of the result of the analysis to allow analysts to be presented with an easily understandable summary of the analysis. The automated analysis is split into two phases: the first phase involves extraction of attributes that are found in the customer reviews; and the second phase involves analyzing each of the customer reviews separately with respect to opinions expressed regarding the attributes. For example, an enterprise may be involved in selling printers. In this example, attributes that are of interest include “printer,” “software,” “paper tray,” “toner,” and so forth. In reviews, customers may express opinions regarding these attributes.

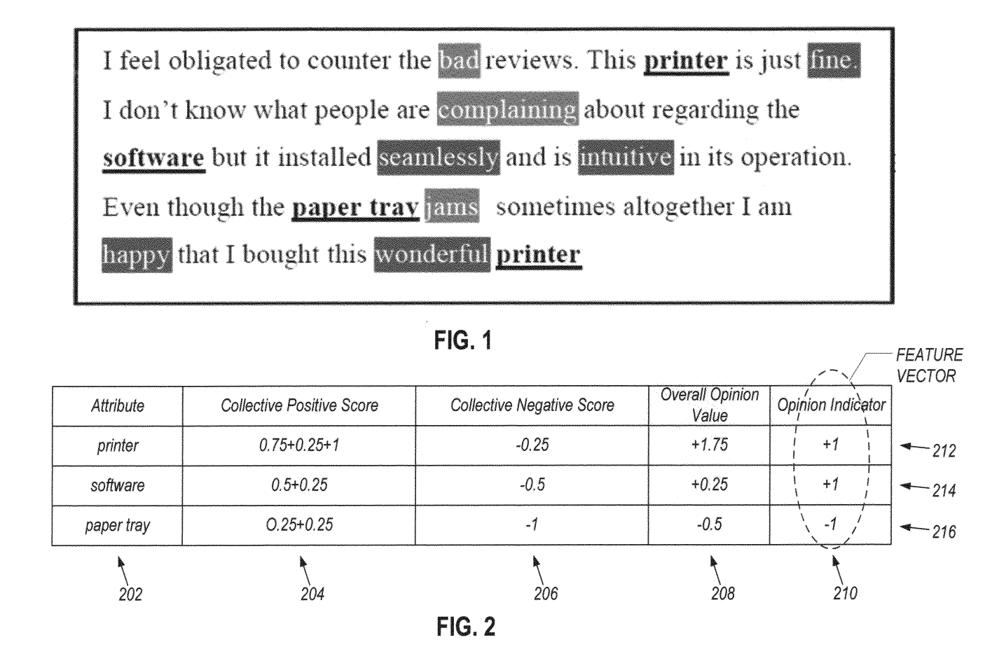

FIG. 1 illustrates an example of a customer review that may have been received by an enterprise. In the example, the attributes of the customer review are bolded and underlined, and include “printer,” “software,” and “paper tray.” Moreover, opinion words are also expressed in the example customer review, where positive opinion words are highlighted in blue (including “fine,” “seamlessly,” “intuitive,” “happy,” and “wonderful”), and negative opinion words are highlighted in red (e.g., “bad,” “complaining,” and “jams”).

In performing the analysis of the review, a distance mapping strategy is employed that takes into account distances between attributes of a review and opinion words expressed in the review. The distance mapping strategy assigns both a positive score and a negative score to each of the attributes in the review, based on the distances between the attribute and corresponding (positive and negative) opinion words in a particular section of the review. The distance between an attribute and a corresponding opinion word can be expressed as the number of words between the attribute and opinion word, the number of characters between the attribute and opinion word, the physical spacing between the attribute and opinion word, or any other spacing measure. In one embodiment, a “section” of a review is a sentence, where a sentence is a group of characters between periods. Note that if the review does not include any periods, then the entire review is considered one sentence. In other embodiments, other types of sections can be used, such as a paragraph, a page, and so forth. In the ensuing discussion, reference is made to performing a distance mapping strategy that computes distances between the attribute and corresponding (positive and negative) opinion words in each sentence of the review. However, techniques according to some embodiments can be applied to other types of sections.

Note that a review can include several sentences. As noted above, the distance mapping strategy considers which sentences the attributes and opinion words are found. When sentences are considered, it is possible that even if the distance between an attribute and the closest opinion word is relatively small, the attribute and opinion word may be found in different sentences, which can be an indication that the relationship between the attribute and the opinion word may be relatively attenuated.

In some embodiments, the distance mapping strategy employs a distance function ƒ(Attrⱼ,OPᵢ), where Atto represents a j-th attribute from the set of attributes, and OPᵢ represents an i-th attribute from a the set of opinion words. For a particular review, values are assigned to the distance mapping function ƒ(Attrⱼ,OPᵢ) based on distances between corresponding attributes and opinion words and whether the attributes and opinion words exist in the same sentence. In one example, assignment of values to the distance function ƒ(Attrⱼ,OPᵢ) is as follows:

$$f ( {Attr}_{j} , {OP}_{i} ) = \{ \begin{matrix}1 & if ( dist ( {Attr}_{j} , {OP}_{i} ) = 0 ) \& ( sentID ( {Attr}_{j} ) = sentID ( {OP}_{i} ) ) , \\ 0.75 & if ( 1 \leq dist ( {Attr}_{j} , {OP}_{i} ) < 3 ) \& ( sentID ( {Attr}_{j} ) = sentID ( {OP}_{i} ) ) , \\ 0.5 & if ( 3 \leq dist ( {Attr}_{j} , {OP}_{i} ) < 5 ) \& ( sentID ( {Attr}_{j} ) = sentID ( {OP}_{i} ) ) , \\ 0.25 & if ( dist ( {Attr}_{j} , {OP}_{i} ) \geq 5 ) \& ( sentID ( {Attr}_{j} ) = sentID ( {OP}_{i} ) ) . \\ 0 & else\end{matrix} \} ,$$

where Attrⱼ is Attribute j, sentID(Attrⱼ) represents the identifier of the sentence in which attribute Attrⱼ is located in, OPᵢ is opinion word i, sentID(OPᵢ) represents the identifier of the sentence that the opinion word OP, is located in, and dist(Attrⱼ,OPᵢ) represents the number of words (or other indication of spacing) between attribute Attrⱼ and opinion word OPᵢ. Also, OP+ is the set of positive opinion words, and OP− is the set of negative opinion words.

According to the above definition of the distance function ƒ(Attrⱼ,OPᵢ), a score of 1 is assigned if the number of words between attribute Attrⱼ and opinion word OPᵢ is zero (in other words, there are no words between the attribute and the opinion word), and the attribute Attrⱼ and opinion word OPᵢ are located in the same sentence; a score of 0.75 is assigned if there are at least one word and less than three words between the attribute Attrⱼ and the opinion word OPᵢ, and the attribute and opinion word are located in the same sentence; a score of 0.5 is assigned if there are at least three words and less than five words between the attribute Attrⱼ and the opinion word OPᵢ, and the attribute and opinion word are located in the same sentence; and a score of 0.25 is assigned if the number of words between the attribute Attrⱼ and the opinion word OPᵢ is greater than or equal to 5 and the attribute and opinion word are located in the same sentence. However, a score of zero is assigned if the attribute and opinion word are located in different sentences.

The foregoing provides just an example of scores can be assigned based on various conditions. In other examples, different distance functions can be defined based on different combinations of conditions.

The opinion words OPᵢ are divided into positive opinion words and negative opinion words. For each attribute, the scores assigned ƒ(Attrⱼ,OPᵢ) for positive opinion words are summed (or otherwise aggregated) to provide a collective positive score, and the scores assigned for negative opinion words are also summed (or otherwise aggregated) to provide a collective negative score.

For each attribute Attrⱼ, a collective positive score is calculated as follows:

Collective Positive Score=Σⱼ₌₀ⁿΣᵢ₌₀^{m}ƒ(dist(Attrⱼ,OP+ᵢ)). (Eq. 1)

Also, for each attribute Attrⱼ, a collective negative score is calculated as follows:

Collective Negative Score=−Σⱼ₌₀ⁿΣᵢ₌₀^{m}ƒ(dist(Attrⱼ,OP−ᵢ)). (Eq. 2)

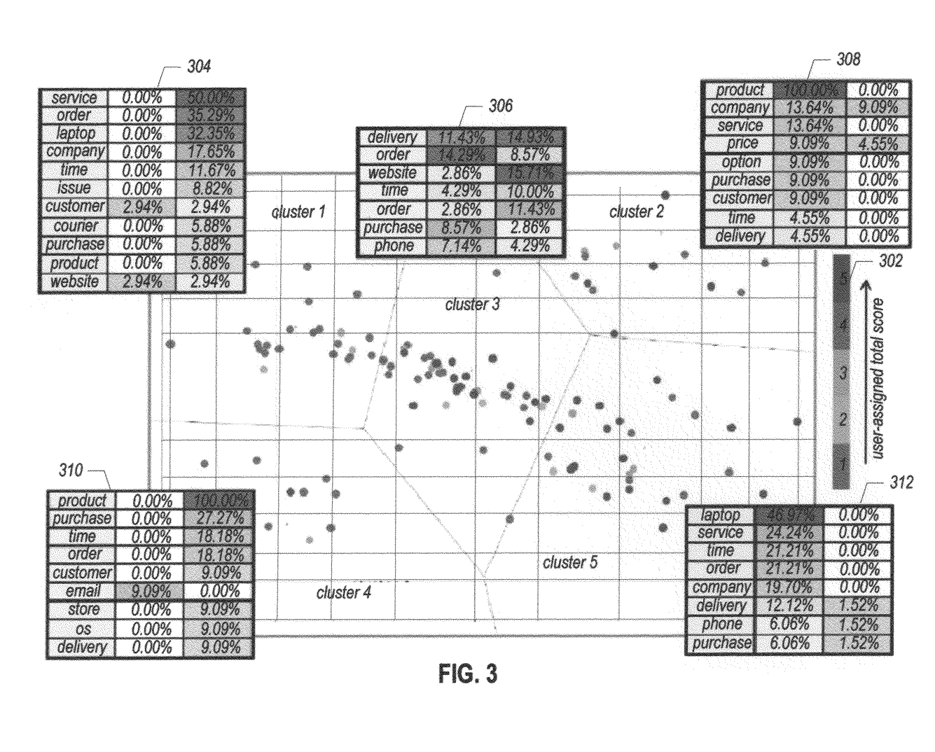

The above is illustrated in a table shown in FIG. 2, which has a first column 202 including the attributes of the example review shown in FIG. 1 (“printer,” “software,” and “paper tray”), a second column 204 containing the collective positive score (calculated according to Eq. 1 above) for each of the attributes in the first column 202, a third column 206 containing the collective negative score (calculated according to Eq. 2 above) for each of the attributes in the first column 202, a fourth column 208 containing a sum of the collective positive score and the collective negative score in respective columns 204 and 206, and an opinion indicator column 210 that can take on predefined discrete values, such as +1 (to indicate an overall positive opinion), −1 (to indicate an overall negative opinion), and zero (to indicate an overall neutral opinion or no opinion).

Thus, in the example of FIG. 2, in row 212, the collective positive score in column 204 is the sum of the individual scores (0.75, 0.25, +1) assigned based on computation of the distance function ƒ(Attrⱼ,OPᵢ) for the attribute “printer” and corresponding positive opinion words, including “fine,” “happy,” and “wonderful” in the review shown in FIG. 1. Similarly, in row 212, in column 206, a collective negative score is provided that is the negative of the sum of the individual scores associated with negative opinion words associated with the attribute “printer.” In this case, there is just one such negative opinion word associated with the attribute “printer” in FIG. 1, and that negative opinion word is “jams.”

In row 212, in column 208, the overall opinion value is the sum of the collective positive score and the collective negative score, which in the row 212 is +1.75. In column 210, the opinion indicator that is assigned to each attribute is based on the overall opinion value in column 208. If the overall opinion value in column 210 is a positive value, then the opinion indicator is assigned +1, such as in rows 212 and 214. However, if the overall opinion value is a negative value, then the opinion indicator is assigned −1, such as in row 216. Although not shown, an overall opinion value of zero would be associated with an opinion indicator of zero.

The opinion indicators in the column 210 shown in Table 1 together form a feature vector. The feature vector associates an opinion indicator with each of the attributes that are found in a corresponding review. For multiple reviews, there will be multiple corresponding feature vectors. Although reference is made to “feature vectors,” it is noted that the opinion indicators can be included in other types of feature data structures that can contain the opinion indicators associated with corresponding attributes.

The feature vectors effectively provide an opinion-to-attribute mapping. The feature vectors that are produced based on the distance mapping strategy discussed above can be employed to produce an interactive visualization of the reviews. An interactive visualization refers to a visualization in which a user (e.g., an analyst or other personnel) can make selections to change what is depicted or to retrieve additional information. In accordance with some embodiments, the interactive visualizations that can be provided include: (1) a scatter plot to depict reviews in clusters (to group reviews into clusters of similar likes and dislikes); or (2) correlation maps between attributes, customer-assigned scores, and review documents (as discussed further below).

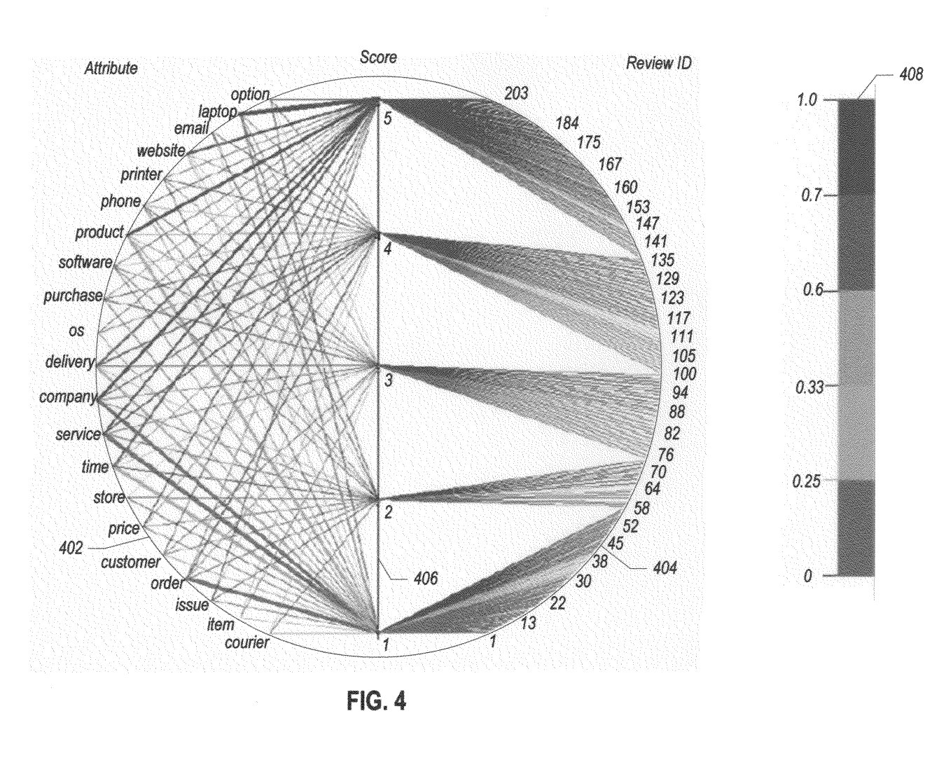

FIG. 3 shows a scatter plot according to one embodiment that can be employed to show the reviews in multiple clusters. In FIG. 3, five clusters are shown: cluster 1, cluster 2, cluster 3, cluster 4, cluster 5. Within each cluster, dots are shown, where each dot represents a review. The clusters divide the reviews into corresponding groups that share similarities in some characteristics. Using the scatter plot of FIG. 3, a reviewer can easily determine attributes within clusters that are liked or disliked by customers.

Positioning of each dot in the scatter plot of FIG. 3 is based on the feature vector associated with the corresponding review. The mapping of the feature vectors into the 2-dimensional scatter plot of FIG. 3 can be accomplished using a multidimensional scaling (MDS) algorithm. The clusters represent reviews that contain similar opinions.

The MDS algorithm is a known statistical technique that can be used for information visualization for exploring similarities or dissimilarities in data. The MDS algorithm starts with a matrix of item-item similarities (which are the feature vectors discussed above), and then assigns a location to each item in an N-dimensional space (where N is equal to 2 in the scatter plot of FIG. 3).

In accordance with some embodiments, colors can be assigned to different dots on the scatter plot, where the colors represent scores assigned by customers for each review. The score is the customer-assigned total score of the review. In FIG. 3, a color scale 302 maps colors to respective scores, where a higher score indicates a better review. The customer-assigned scores can range between 1 and 5 in this example. A dark blue is assigned to a customer-assigned total score of 5, while a dark red is assigned to a customer-assigned total score of 1. Different colors are assigned to scores of 2, 3, and 4, to allow an analyst to distinguish between different scores assigned by customers for corresponding reviews visualized in the scatter plot of FIG. 3.

The visualization of FIG. 3 is an interactive visualization that allows a user to employ a user input device (such as a mouse) to move a cursor over selected ones of the dots shown in FIG. 3. In response to some user activation, such as a double click, pop-up lists can be displayed, including pop-up lists 304, 306, 308, 310, and 312. Each pop-up list lists the most important attributes associated with the corresponding cluster of reviews. In each list, there are three columns, including a first column that contains the most commented attributes, a second column that indicates percentages of positive comments associated with corresponding attributes, and a third column that indicates percentages of negative comments. Attributes are considered to be more “commented” if the attributes are associated with relatively high amounts of negative and/or positive comments/opinions.

In the example list 304, for the attribute “service” there were 0% positive comments, while 50% of the comments associated with the attribute “service” were negative. Similarly, 35.29% of the comments associated with the attribute “order” were negative, and 32.35% of the comments associated with attribute “laptop” were negative. Thus, for this cluster of reviews, an analyst can easily determine that the corresponding customers in the cluster were mostly unhappy with the service associated with ordering of a laptop.

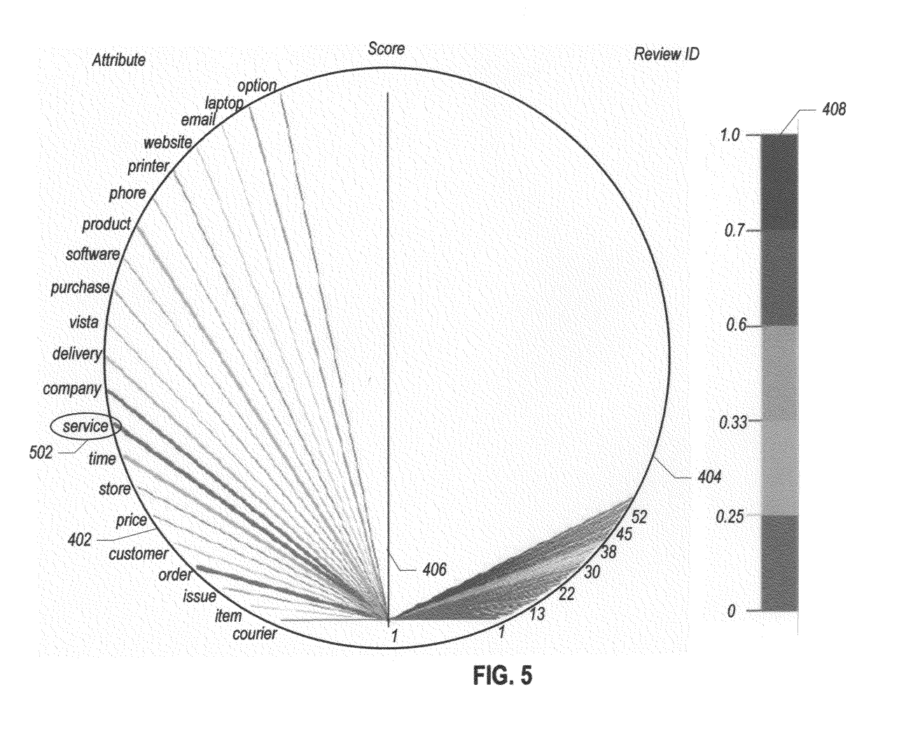

Another type of visualization that can be provided is a circular correlation map. As shown in FIG. 4, an example circular correlation map has a left arc 402, a right arc 404, and a middle vertical axis 406. The left arc 402 has positions (elements) representing respective attributes that are found in the reviews, the right arc 404 has positions (elements) representing identifiers of the reviews, and the middle vertical axis 406 has positions (elements) representing the customer-assigned total scores (assigned to the reviews). In the example of FIG. 4, there are five possible total scores (1-5). For each attribute in each review, a line is drawn from the position of the review identifier on the right arc 404 to the corresponding customer-assigned total score in the middle axis that has been assigned by the customer. Another line is drawn from the corresponding customer-assigned total score to the respective attribute on the left arc 402.

Colors are assigned to the lines drawn between attributes and the customer-assigned total scores, and to lines drawn between review identifiers and the customer-assigned total scores. A color scale 408 is also shown in FIG. 4. The color that is assigned to a line represents a percentage of positive comments. Between the middle axis 406 and the review identifiers in the right arc 404, a blue line indicates that there is a larger percentage of positive comments than negative comments in the corresponding review, while a red line indicates that there are a greater percentage of negative comments than positive comments in the review.

The color assigned to a line between an attribute on the left arc 402 and a customer-assigned total score on the middle axis 406 represents the percentage of positive or negative comments associated with the attribute over the entire set of reviews. A red line between an attribute and a customer-assigned total score indicates that there is a larger percentage of negative comments than positive comments for the attribute over the subset of reviews with a specific score. On the other hand, a blue line between an attribute and a customer-assigned total score indicates that there is a larger percentage of positive comments than negative comments for the attribute over the subset of reviews with a specific score.

In the example of FIG. 4, the largest numbers of positive comments are provided to the attributes “option,” “laptop,” and “email,” since the greatest number of blue lines are connected to these three attributes as shown in the upper portion of the left arc 402. The positions of the attributes on the left arc 402 are ordered by percentages of positive comments, with attributes associated with higher percentages of positive comments placed higher on the arc 402. Different orderings can be employed in other implementations. The most frequent score is 4, based on the largest number of lines connecting the score of 4 with document identifiers on the right arc 404.

Although reference is made to a circular correlation map, it is noted that in other embodiments, other correlation maps can be employed that has a first section to represent attributes, a second section to represent review identifiers, and another section to represent customer-assigned total scores.

To allow users to interactively analyze the distribution of comments over the scores and attributes, a user can select for display just a portion of what is shown in FIG. 4. For example, to focus on attributes and reviews associated with the customer-assigned total score of 1, a user can click on the point corresponding to the score of 1 on the middle axis 406, which causes a partial visualization to be depicted as shown in FIG. 5. In FIG. 5, all the lines that are drawn to the other scores (2-5) have been removed.

To further focus on one of the attributes, a user can double-click on the “service” attribute (502 in FIG. 5), which causes the visualization of FIG. 6 to be displayed. In FIG. 6, lines drawn from the “service” attribute to each of the scores 1-5 are shown, and further lines are drawn between the scores and elements on the right arc 406 that represent reviews containing the attribute “service.”

The frequency with which an attribute is commented on is mapped to the thickness of the line in the left semi-circle. Thus, a thick red line that is connected to attribute “service” suggests that one of the main reasons why those customers decide to give such a low score is their dissatisfaction with the attribute “service.” FIG. 6 shows that not all the customers were dissatisfied with the service, and confirms that this attribute is over-rated negatively by reviews which gave an overall score of 1.

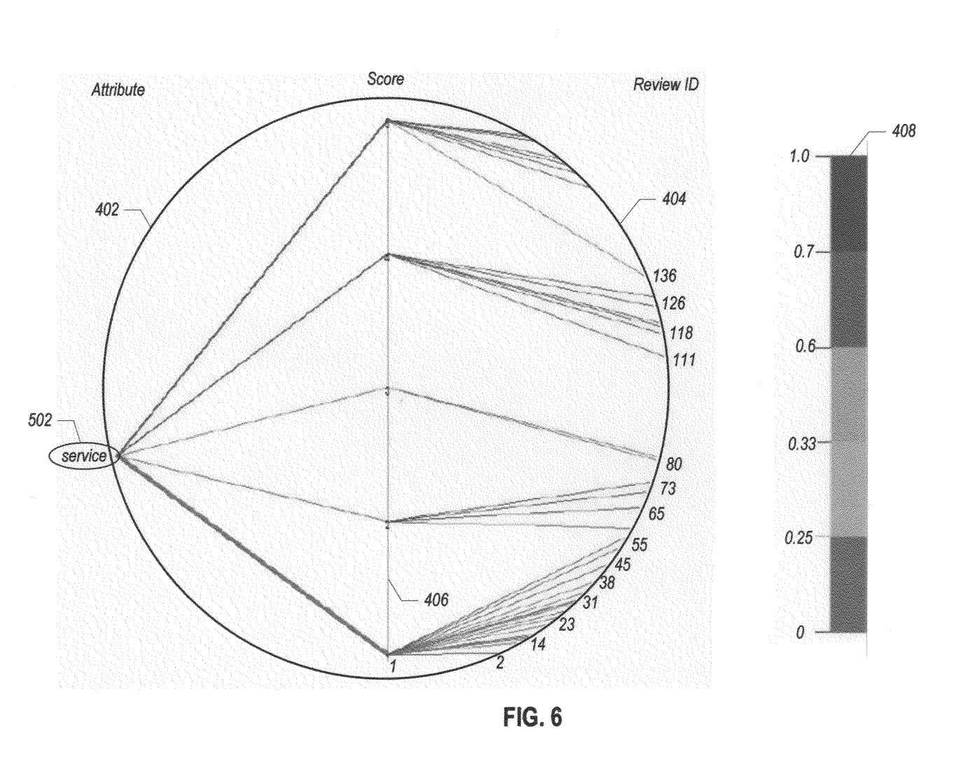

FIG. 7 is a flow diagram of a general process according to an embodiment. Reviews are input into an attribute extraction block 702, which extracts attributes found in the reviews. The reviews that are input to the attribute extraction block 702 can be in text form or in another form. Attribute extraction can be performed using standard text mining techniques.

Next, after attributes have been extracted, the result of the attribute extraction are provided to a feature extraction block 704, which performs the distance mapping strategy discussed above. The feature vectors produced by the distance mapping strategy are input to a circular correlation map visualization block 706, which displays the circular correlation map as shown in FIG. 4-6. Note that the customer-assigned scores are those given by the customers.

The feature vectors from the feature extraction block 704, as well as customer-assigned total scores, are also output to a multi-dimensional scaling block 708, which produces an output to allow a scatter plot visualization 710, such as the scatter plot visualization of FIG. 3.

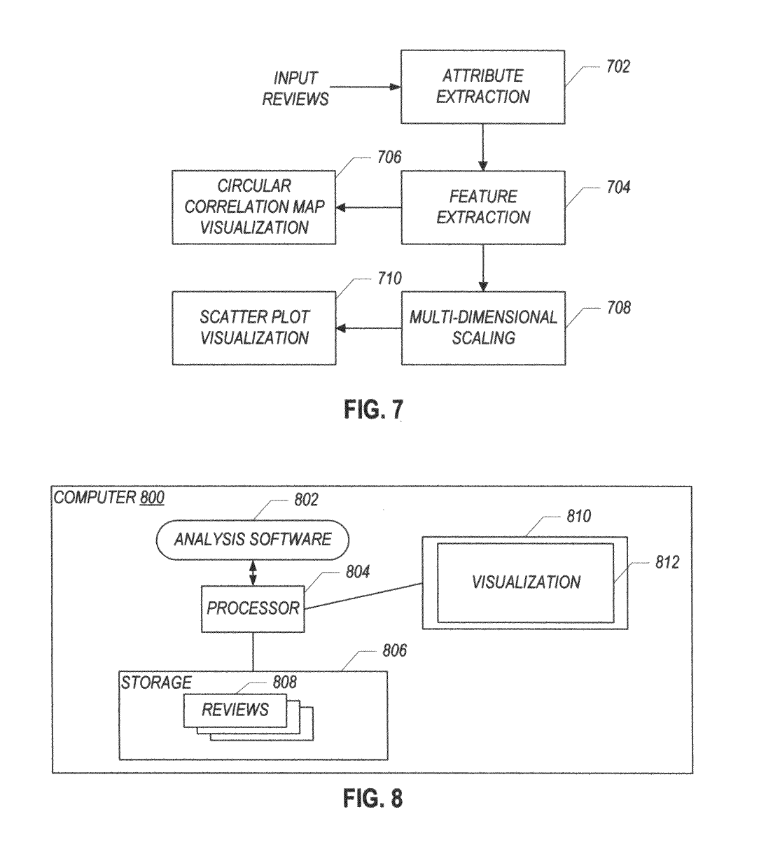

The tasks of FIG. 7 can be performed by a computer 800 shown in FIG. 8. The computer 800 includes analysis software 802, which can include various software modules to perform attribute extraction, feature extraction, circular correlation map visualization, multidimensional scaling, and scatter plot visualization, as shown in FIG. 7. The analysis software 802 is executable on a processor 804, which is connected to storage media 806 (implemented with one or more disk-based storage devices and/or one or more integrated circuit or semiconductor memory devices) that contains documents (or other representations) of reviews 808 that have been received by the computer 800. The analysis software 802 accesses the reviews 808 to perform the analysis discussed above, as well as to produce visualizations 812 that are displayed on a display device 810.

Although reference is made to a computer 800, note that “computer” can refer to a single computer node or to multiple computer nodes, where the multiple computer nodes can be distributed and connected over one or more networks.

Instructions of the analysis software 802 are loaded for execution on the processor 804. The processor 804 includes microprocessors, microcontrollers, processor modules or subsystems (including one or more microprocessors or microcontrollers), or other control or computing devices. As used here, a “processor” can refer to a single component or to plural components (e.g., one or plural CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
receiving representations of reviews regarding at least one offering of an enterprise, wherein the representations of the reviews contain attributes and opinion words;
determining, by a computer, distance associations between the attributes and the opinion words in the representations according to a distance mapping strategy that uses distances between the attributes and the opinion words in a section; and
generating, by the computer, a visualization of the reviews according to the determined associations.

2. The method of claim 1, further comprising:
generating, by the computer, feature data structures for corresponding reviews, wherein each of the feature data structures maps attributes and corresponding opinion indicators that are based on the determined associations,
wherein generating the visualization of the reviews is according to the feature data structures.

3. The method of claim 2, wherein generating the visualization comprises depicting clusters of the reviews in the visualization based on the feature data structures.

4. The method of claim 3, wherein depicting the clusters of the reviews by positioning the reviews in the visualization based on the feature data structures.

5. The method of claim 2, further comprising:
displaying, in response to interactive user selection, a list of attributes associated with at least a particular cluster of the reviews, wherein the list further contains amounts of positive or negative opinions associated with the attributes in the list.

6. The method of claim 5, further comprising associating colors with the amounts to indicate positive or negative opinions.

7. The method of claim 5, wherein the list identifies more positively and/or negatively commented attributes of the cluster of reviews.

8. The method of claim 1, further comprising generating a correlation map having plural sections, wherein a first of the plural sections includes elements representing the attributes, a second of the plural sections includes elements representing the reviews, and a third of the plural sections includes elements representing scores associated with the reviews.

9. The method of claim 8, wherein the first and second sections include corresponding first and second arcs of the correlation map, and wherein the third section is an axis between the first and second arcs.

10. The method of claim 8, further comprising drawing lines connecting the elements of the first section with elements of the third section, and drawing lines connecting the elements of the second section with elements of the third section.

11. The method of claim 10, further comprising assigning colors to the lines to indicate percentages of positive or negative reviews.

12. The method of claim 8, further comprising receiving user selections of the elements of the correlation map to cause display a portion of the correlation map.

13. The method of claim 1, wherein generating the visualization comprises generating an interactive visualization.

14. The method of claim 1, wherein the section is a sentence.

15. An article comprising at least one computer-readable storage medium containing instructions that upon execution cause a computer to:
analyze documents containing reviews of at least one offering of an enterprise to determine relationships between attributes of the at least one offering and opinion words in the documents, wherein the analyzing is based on distances between the attributes and the opinion words; and
generate a visualization of the reviews, wherein the visualization displays representations of the attributes, customer opinions, and the reviews.

16. The article of claim 15, wherein the visualization includes a scatter plot having points representing corresponding reviews.

17. The article of claim 16, wherein the instructions upon execution cause the computer to further cluster the points in the visualization according to similarities of customer opinions regarding a set of attributes in the reviews.

18. The article of claim 15, wherein the visualization includes a correlation map that correlates reviews, attributes, and scores of the reviews.

19. The article of claim 15, wherein colors are assigned to elements in the visualization based on percentage of positive or negative comments.

20. The article of claim 15, wherein determining the relationships between the attributes and the opinion words comprises determining feature vectors that each maps attributes of a corresponding review to respective opinion indicators that represent an overall aggregated positive and negative scores of the corresponding review.

21. A computer comprising:
a storage media to store reviews received regarding at least one offering of an enterprise; and
a processor to:
apply a distance mapping strategy to the reviews to determine associations between attributes of the reviews and corresponding opinion words,
produce a visualization of the reviews according to the determined associations between the attributes and the corresponding opinion words.

22. The computer of claim 21, wherein applying the distance mapping strategy causes production of feature vectors that map attributes of corresponding reviews to respective opinion indicators.
